(19) United States
(12) Patent Application Publication
(10) Pub. No.: US 2022/0255061 A1
(43) Pub. Date: Aug. 11, 2022

(54) NONAQUEOUS ELECTROLYTE ENERGY STORAGE DEVICE, METHOD FOR MANUFACTURING THE SAME, AND ENERGY STORAGE APPARATUS

(71) Applicant: GS Yuasa International Ltd., Kyoto-shi, Kyoto (JP)

(72) Inventors: Fumiya KONDO, Kyoto (JP); Takashi KANEKO, Kyoto (JP)

(21) Appl. No.: 17/624,753

(22) PCT Filed: Jul. 22, 2020
(86) PCT No.: PCT/JP2020/028499

§ 371 Date: Jan. 4, 2022

(30) Foreign Application Priority Data
Aug. 1, 2019 (JP) 2019-142449

(51) Int. Cl. H01M 4/36; H01M 4/505; H01M 4/525; H01M 4/587; H01M 10/0525

(52) U.S. Cl. CPC H01M 4/364; H01M 4/505; H01M 2004/027; H01M 4/587; H01M 10/0525; H01M 4/525

(57) ABSTRACT

One aspect of the present invention is a nonaqueous electrolyte energy storage device including: a positive electrode; and a negative electrode containing silicon oxide, wherein an initial irreversible capacity of the positive electrode to an initial irreversible capacity of the negative electrode is 1.15 or more.

### TECHNICAL FIELD

The present invention relates to a nonaqueous electrolyte energy storage device, a method for manufacturing the same, and an energy storage apparatus.

### BACKGROUND ART

Nonaqueous electrolyte secondary batteries typified by lithium ion secondary batteries are widely used for electronic devices such as personal computers and communication terminals, automobiles and the like because these secondary batteries have a high energy density. The nonaqueous electrolyte secondary battery is generally provided with an electrode assembly having a pair of electrodes electrically isolated by a separator, and a nonaqueous electrolyte interposed between the electrodes and is configured to charge and discharge by transferring ions between both the electrodes. Capacitors such as lithium ion capacitors and electric double-layer capacitors are also widely in use as nonaqueous electrolyte energy storage devices except for the secondary batteries.

As one of such nonaqueous electrolyte energy storage devices, an energy storage device including silicon oxide as an active material for a negative electrode has been developed (see Patent Documents 1 to 5). The silicon oxide has an advantage of having a larger capacity than that of a carbon material widely used as a negative active material.

### PRIOR ART DOCUMENTS

### Patent Documents

Patent Document 1: JP-A-2011-113863
Patent Document 2: JP-A-2015-053152
Patent Document 3: JP-A-2014-120459
Patent Document 4: JP-A-2015-088462
Patent Document 5: WO2012/169282 A

### DISCLOSURE OF THE INVENTION

### Problems to be Solved by the Invention

However, in the silicon oxide, particles are apt to crack or be isolated due to repeated expansion and contraction during charge-discharge. Therefore, the nonaqueous electrolyte energy storage device including the silicon oxide has been known to have a low capacity retention ratio in a charge-discharge cycle.

The present invention has been made based on the above circumstances, and an object of the present invention is to provide a nonaqueous electrolyte energy storage device containing silicon oxide as a negative electrode and having an improved capacity retention ratio in a charge-discharge cycle, a method for manufacturing such a nonaqueous electrolyte energy storage device, and an energy storage apparatus including such a nonaqueous electrolyte energy storage device.

### Means for Solving the Problems

One aspect of the present invention made to solve the above problems is a nonaqueous electrolyte energy storage device including: a positive electrode; and a negative electrode containing silicon oxide, wherein a ratio of an initial irreversible capacity of the positive electrode to an initial irreversible capacity of the negative electrode is 1.15 or more.

Another aspect of the present invention is a method for manufacturing a nonaqueous electrolyte energy storage device, the method including: producing a positive electrode; producing a negative electrode containing silicon oxide; and performing initial charge-discharge, wherein a ratio of an initial irreversible capacity of the positive electrode to an initial irreversible capacity of the negative electrode is 1.15 or more.

Another aspect of the present invention is an energy storage apparatus configured by assembling a plurality of nonaqueous electrolyte energy storage devices, wherein at least one of the plurality of nonaqueous electrolyte energy storage devices is the nonaqueous electrolyte energy storage device according to one aspect of the present invention.

### Advantages of the Invention

One aspect of the present invention can provide a nonaqueous electrolyte energy storage device containing silicon oxide as a negative electrode and having an improved capacity retention ratio in a charge-discharge cycle, a method for manufacturing such a nonaqueous electrolyte energy storage device, and an energy storage apparatus including such a nonaqueous electrolyte energy storage device.

### BRIEF DESCRIPTION OF THE DRAWINGS

FIG. 1 is a diagram schematically showing initial charge-discharge curves of positive electrodes and negative electrodes of a nonaqueous electrolyte energy storage device according to one aspect of the present invention and a conventional nonaqueous electrolyte energy storage device.

FIG. 2 is a diagram schematically showing the initial discharge curve of the negative electrode additionally when an initial irreversible capacity ratio (Q′c/Q′a) is made larger in the initial charge-discharge curve of the nonaqueous electrolyte energy storage device according to one aspect of the present invention of FIG. 1.

FIG. 3 is a transparent perspective view showing an embodiment of a nonaqueous electrolyte energy storage device.

FIG. 4 is a schematic diagram showing an embodiment of an energy storage apparatus including a plurality of nonaqueous electrolyte energy storage devices.

FIG. 5 is a graph showing the relationship between the initial irreversible capacity ratio (Q′c/Q′a) and the capacity retention ratio in the charge-discharge cycle of each of nonaqueous electrolyte energy storage devices of Examples 1 and 2 and Comparative Examples 1 and 2.

FIG. 6 shows a graph showing the relationship between the initial irreversible capacity ratio (Q′c/Q′a) and the average discharge voltage retention ratio in the depth of discharge (DOD) of 50% to 100% in the charge-discharge cycle of each of the nonaqueous electrolyte energy storage devices of Examples 3 to 6.

FIG. 7 is a graph showing the relationship between the initial irreversible capacity ratio (Q′c/Q′a) and the energy retention ratio in the depth of discharge (DOD) of 50% to 100% in the charge-discharge cycle of each of the nonaqueous electrolyte energy storage devices of Examples 3 to 6.

FIG. 8 is a graph showing a difference in the discharge curve of the negative electrode depending on the presence or absence of suppression of the accumulation of a high crystal phase, which will be described later.

### MODE FOR CARRYING OUT THE INVENTION

One aspect of the present invention is a nonaqueous electrolyte energy storage device (a) including: a positive electrode; and a negative electrode containing silicon oxide, wherein a ratio of an initial irreversible capacity of the positive electrode to an initial irreversible capacity of the negative electrode is 1.15 or more.

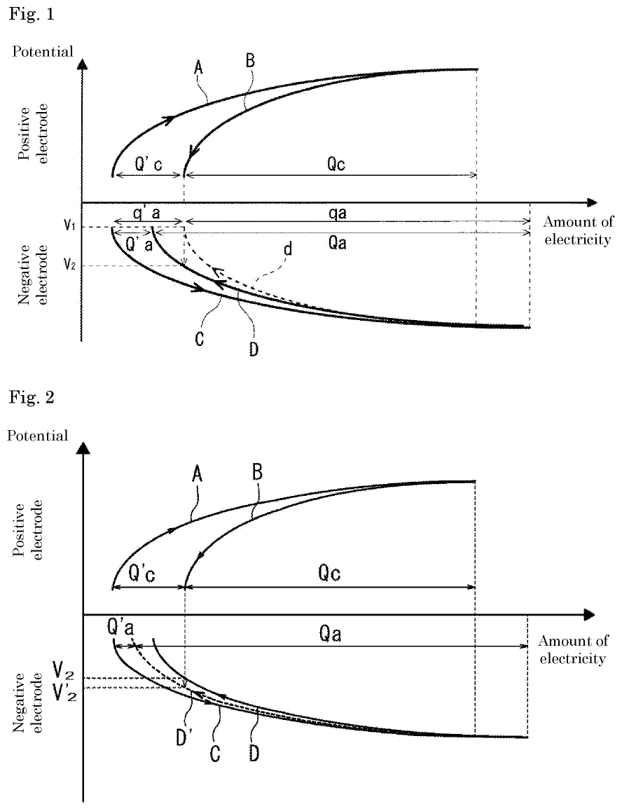

The nonaqueous electrolyte energy storage device (a) is a nonaqueous electrolyte energy storage device using silicon oxide as a negative electrode, and has an improved capacity retention ratio in a charge-discharge cycle. Although the reason why such an effect occurs is not clear, the following reason is presumed. FIG. 1 schematically shows an initial charge-discharge curve in a conventional nonaqueous electrolyte energy storage device using silicon oxide as a negative electrode and an initial charge-discharge curve in a nonaqueous electrolyte energy storage device (α) according to one aspect of the present invention. In FIG. 1, the charge-discharge curve of the positive electrode and the charge curve of the negative electrode are the same for the conventional nonaqueous electrolyte energy storage device and the nonaqueous electrolyte energy storage device (α) according to one aspect of the present invention. In FIG. 1, a curve A represents the initial charge curve of the positive electrode; a curve B represents the initial discharge curve of the positive electrode; a curve C represents the initial charge curve of the negative electrode; a curve (broken line) d is the initial discharge curve of the negative electrode of the conventional nonaqueous electrolyte energy storage device; and a curve D represents the initial discharge curve of the negative electrode of the nonaqueous electrolyte energy storage device (α) according to one aspect of the present invention. Qc represents the initial reversible capacity of the positive electrode; Q′c is the initial irreversible capacity of the positive electrode; Qa is the initial reversible capacity of the negative electrode of the nonaqueous electrolyte energy storage device (α) according to one aspect of the present invention; Q′a represents the initial irreversible capacity of the negative electrode of the nonaqueous electrolyte energy storage device (α) according to one aspect of the present invention; qa represents the initial reversible capacity of the negative electrode of the conventional nonaqueous electrolyte energy storage device; and q′a represents the initial irreversible capacity of the negative electrode of the conventional nonaqueous electrolyte energy storage device. In the conventional nonaqueous electrolyte energy storage device using the silicon oxide as the negative electrode, an increase in the negative electrode potential (V₁) in the state of a depth of discharge (DOD) of 100%, as represented by the initial discharge curve d of the negative electrode is considered to cause a decrease in the capacity retention ratio in the charge-discharge cycle. That is, a large amount of lithium ions and the like inserted and extracted in the negative electrode due to charge-discharge cause large change in expansion and contraction of the negative electrode, whereby particles are apt to crack or be isolated, which causes a decrease in the capacity retention ratio of the nonaqueous electrolyte energy storage device in the charge-discharge cycle. Meanwhile, in the nonaqueous electrolyte energy storage device (α) according to one aspect of the present invention, the initial irreversible capacity (Q′c) of the positive electrode to the initial irreversible capacity (Q′a) of the negative electrode, that is, the initial irreversible capacity ratio (Q′c/Q′a) is increased to 1.15 or more. This provides a low negative electrode potential (V₂) in the state of 100% DOD. As a result, It is presumed that, in the nonaqueous electrolyte energy storage device (α), the change in expansion and contraction of the silicon oxide particles is decreased, whereby the cracking and isolation of the silicon oxide particles are suppressed, which provides an improvement in the capacity retention ratio in the charge-discharge cycle.

The initial irreversible capacity of the positive electrode of the nonaqueous electrolyte energy storage device (the initial irreversible capacity per unit area) is a difference (charge capacity-discharge capacity) between a charge capacity and a discharge capacity per unit area of a positive electrode X when charging-discharging a unipolar battery including the positive electrode X before charge-discharge in which a portion facing the negative electrode to contribute to charge-discharge is produced by the same formulation as that of the positive electrode of the nonaqueous electrolyte energy storage device as a working electrode, and metal Li as a counter electrode. Similarly, the initial irreversible capacity of the negative electrode of the nonaqueous electrolyte energy storage device (the initial irreversible capacity per unit area) is a difference (charge capacity-discharge capacity) between a charge capacity and a discharge capacity per unit area of a negative electrode X when charging-discharging a unipolar battery including the negative electrode X before charge-discharge in which a portion facing the positive electrode to contribute to charge-discharge is produced by the same formulation as that of the negative electrode of the nonaqueous electrolyte energy storage device as a working electrode, and metal Li as a counter electrode.

A specific method for measuring the charge capacity and the discharge capacity of the positive electrode X is as follows. The unipolar battery is assembled with the positive electrode X as the working electrode and the metal Li as the counter electrode, and charge-discharge is performed for one cycle as follows. A charge current is a current corresponding to 0.1 C with respect to the discharge capacity (mAh) of the positive electrode X calculated based on the theoretical discharge capacity (mAh/g) per mass of the positive active material. Charge is performed at a constant current until the potential of the working electrode when the nonaqueous electrolyte energy storage device actually applied is in the state of 100% SOC reaches the value of a positive electrode potential (V vs. Li/Li⁺) planned by a designer, and constant potential charge is then performed at the potential for a total charge time of 30 hours, to obtain a charge capacity. After a rest time of 10 minutes, constant current discharge is performed using the same current value as the charge current as the discharge current. When the potential of the working electrode when the nonaqueous electrolyte energy storage device actually applied is in the state of 100% DOD reaches the value of the positive electrode potential (V vs. Li/Li⁺) planned by the designer, the discharge is ended, and a discharge capacity is obtained.

A specific method for measuring the charge capacity and the discharge capacity of the negative electrode X is as follows. The unipolar battery is assembled with the negative electrode X as the working electrode and the metal Li as the counter electrode, and charge-discharge is performed for one cycle. Here, operation of energizing the negative electrode X in the direction of electrochemical reduction is referred to as charge, and operation of energizing the negative electrode X in the direction of electrochemical oxidation is referred to as discharge. First, a charge current is a current corresponding to 0.1 C with respect to the discharge capacity (mAh) of the negative electrode X calculated based on the theoretical discharge capacity (mAh/g) per mass of the negative active material. Charge is performed at a constant current until the potential of the working electrode reaches 0.02 V vs. Li/Li⁺, and constant potential charge is then performed at the potential for a total charge time of 30 hours, to obtain a charge capacity. After a rest time of 10 minutes, constant current discharge is performed using the same current value as the charge current as the discharge current. When the potential of the working electrode reaches 2.0 V vs. Li/Li⁺, the discharge is ended, and a discharge capacity is obtained.

It is preferable that the open circuit potential of the negative electrode of the nonaqueous electrolyte energy storage device (α) in the state of 100% DOD is 0.53 V vs. Li/Li⁺ or less. As described above, the open circuit potential of the negative electrode in the state of 100% DOD is 0.53 V vs. Li/Li⁺ or less, whereby the change in expansion and contraction of the silicon oxide particles is sufficiently small, which can further increase the capacity retention ratio of the nonaqueous electrolyte energy storage device (α) in the charge-discharge cycle.

The procedure for adjusting the nonaqueous electrolyte energy storage device to the state of 100% DOD is as follows.

First, the nonaqueous electrolyte energy storage device is set to the state of 100% SOC. As a method for setting the state of SOC to 100%, a charge method specified for the nonaqueous electrolyte energy storage device is adopted. If there is a charger dedicated to the nonaqueous electrolyte energy storage device, the nonaqueous electrolyte energy storage device is fully charged by using the charger. If the charge method specified for the nonaqueous electrolyte energy storage device is not clear, first, a discharge current of 0.2 C is adopted for the rated capacity (mAh) of the nonaqueous electrolyte energy storage device. Constant current discharge is performed at an end voltage of 2.0 V, and the nonaqueous electrolyte energy storage device is then left for 10 minutes. A charge current of 0.02 C is then adopted to perform constant current charge for a charge time of 50 hours, thereby completely charging. The charge of the nonaqueous electrolyte energy storage device is completed, and the nonaqueous electrolyte energy storage device is then left for 10 minutes.

Next, constant current discharge is performed with a current corresponding to 0.2 C as a discharge current. A discharge time is 5 hours. An amount of electricity corresponding to the rated capacity of the nonaqueous electrolyte energy storage device is discharged by the above procedure, and as a result, the nonaqueous electrolyte energy storage device is adjusted to the state of 100% DOD. If the nonaqueous electrolyte energy storage device is not provided with a reference electrode, seal is opened in an atmosphere with a dew point of −30° C. or less with the nonaqueous electrolyte energy storage device adjusted to 100% DOD, and the negative electrode potential can be measured by using the reference electrode.

The ratio of the initial irreversible capacity of the positive electrode to the initial irreversible capacity of the negative electrode is preferably 1.55 or less. As described above, by setting the initial irreversible capacity ratio (Q′c/Q′a) to 1.55 or less, the discharge voltage retention ratio in the utilization region of the silicon oxide in the charge-discharge cycle is improved. Although the reason why such an effect occurs is not clear, the following reason is presumed. FIG. 2 additionally shows a curve (broken line) D′ in which the initial reversible capacity Qa is large and the initial irreversible capacity Q′a is small as the initial discharge curve of the negative electrode in the initial charge-discharge curves A, B, C, and D of FIG. 1. As shown in FIG. 2, when the initial irreversible capacity ratio (Q′c/Q′a) is made larger, the negative electrode potential (V₂′) in the state of 100% DOD becomes lower. In this case, even when the state of DOD is 100%, the lithium occluded in the silicon oxide is not completely released, and an amorphous alloy phase (a-LiₓSi_{y}) remains. Since a-LiₓSi_{y} has higher electron conductivity than that of other phase (a-Si) in the silicon oxide, the reaction between a-LiₓSi_{y} and lithium proceeds when charge is performed in a state where a-LiₓSi_{y} remains, and a high crystal phase, which is presumed to be derived from the formation of c-Li₁₅Si₄, is likely to be generated. By repeating charge-discharge, the high crystal phase is accumulated, and the discharge voltage gradually decreases. As described above, when the negative electrode potential in the state of 100% DOD is too low, the discharge voltage retention ratio in the utilization region of the silicon oxide is lowered due to the accumulation of the high crystal phase due to the repeated charge-discharge. Meanwhile, even if the high crystal phase is formed when the negative electrode potential in the state of 100% DOD is high to some extent, the high crystal phase returns to a-Si during discharge, whereby the accumulation of the high crystal phase is unlikely to occur. As described above, by setting the initial irreversible capacity ratio (Q′c/Q′a) to 1.55 or less, the residual amount of a-LiₓSi_{y} in the state of 100% DOD is reduced, and the accumulation of the above high crystal phase is suppressed. As a result, the discharge voltage retention ratio in the utilization region of the silicon oxide is presumed to be improved. As described above, by setting the initial irreversible capacity ratio (Q′c/Q′a) to 1.55 or less to suppress the procedure of the accumulation of the high crystal phase, a change in a discharge curve shape and a decrease in discharged energy due to repeated charge-discharge can be suppressed. Furthermore, by setting the initial irreversible capacity ratio (Q′c/Q′a) to 1.55 or less, the capacity retention ratio in the charge-discharge cycle tends to be further increased.

It is preferable that the open circuit potential of the negative electrode of the nonaqueous electrolyte energy storage device (α) in the state of 100% DOD is 0.485 V vs. Li/Li⁺ or more. As described above, when the open circuit potential of the negative electrode in the state of 100% DOD is 0.485 V vs. Li/Li⁺ or more, the accumulation of the high crystal phase is further suppressed, whereby the discharge voltage retention ratio in the utilization region of the silicon oxide in the charge-discharge cycle is further improved.

Another aspect of the present invention is a nonaqueous electrolyte energy storage device (β) including: a positive electrode; and a negative electrode containing silicon oxide, wherein a ratio of an initial irreversible capacity of the positive electrode to an initial irreversible capacity of the negative electrode is 1.55 or less.

In a conventional nonaqueous electrolyte energy storage device using silicon oxide as a negative electrode, a discharge voltage may decrease due to the accumulation of the high crystal phase in a charge-discharge cycle. Another aspect of the present invention has been made based on the above circumstances, and an object of the present invention is to provide a nonaqueous electrolyte energy storage device using silicon oxide as a negative electrode and having an improved discharge voltage retention ratio in the utilization region of the silicon oxide in a charge-discharge cycle. That is, the nonaqueous electrolyte energy storage device (β) is the nonaqueous electrolyte energy storage device using the silicon oxide as the negative electrode, and has an improved discharge voltage retention ratio in the utilization region of the silicon oxide in the charge-discharge cycle. Although the reason why such an effect occurs is not clear, as described above, by setting the initial irreversible capacity ratio (Q′c/Q′a) to 1.55 or less, the accumulation of the high crystal phase is suppressed, and as a result, the discharge voltage retention ratio in the utilization region of the silicon oxide is presumed to be improved.

It is preferable that the open circuit potential of the negative electrode of the nonaqueous electrolyte energy storage device (β) in the state of 100% DOD is 0.485 V vs. Li/Li⁺ or more. In such a case, the discharge voltage retention ratio in the utilization region of the silicon oxide in the charge-discharge cycle is further improved.

In the nonaqueous electrolyte energy storage device (α) and the nonaqueous electrolyte energy storage device (β), the negative electrode may further contain graphite. Since the working potential region of the graphite is lower than the working potential region of the silicon oxide, the discharge reactions of the graphite and the silicon oxide do not substantially form a competitive reaction. Therefore, in both the case where only the silicon oxide is contained in the negative electrode and the case where the silicon oxide and the graphite are contained in the negative electrode, the initial irreversible capacity ratio (Q′c/Q′a) is set to 1.15 or more to provide an effect of increasing the capacity retention ratio of the nonaqueous electrolyte energy storage device in the charge-discharge cycle, and the initial irreversible capacity ratio (Q′c/Q′a) is set to 1.55 or less to provide an effect of increasing the discharge voltage retention ratio in the utilization region of the silicon oxide of the nonaqueous electrolyte energy storage device in the charge-discharge cycle.

The term “graphite” refers to a carbon material in which an average grid distance (d₀₀₂) of a (002) plane determined by an X-ray diffraction method before charge-discharge or in a discharged state is 0.33 nm or more and less than 0.34 nm. The “discharged state” of the graphite refers to a state where an open circuit voltage is 0.7 V or more in a unipolar battery using a negative electrode containing graphite as a negative active material as a working electrode and using metallic Li as a counter electrode. Since the potential of the metallic Li counter electrode in an open circuit state is substantially equal to an oxidation/reduction potential of Li, the open circuit voltage in the unipolar battery is substantially equal to the potential of the negative electrode containing the graphite with respect to the oxidation/reduction potential of Li. That is, the fact that the open circuit voltage in the unipolar battery is 0.7 V or more means that lithium ions that can be occluded and released in association with charge-discharge are sufficiently released from the graphite that is the negative active material.

In the nonaqueous electrolyte energy storage device (α) and the nonaqueous electrolyte energy storage device (β), it is preferable that the positive electrode contains a lithium transition metal composite oxide having an α-NaFeO₂-type crystal structure or a spinel-type crystal structure. When such a positive active material is contained in the positive electrode, the discharge capacities of the nonaqueous electrolyte energy storage device (α) and the nonaqueous electrolyte energy storage device (β) can be increased.

Another aspect of the present invention is a method for manufacturing a nonaqueous electrolyte energy storage device (α), the method including: producing a positive electrode; producing a negative electrode containing silicon oxide; and performing initial charge-discharge, wherein a ratio of an initial irreversible capacity of the positive electrode to an initial irreversible capacity of the negative electrode is 1.15 or more.

According to the manufacturing method (a), a nonaqueous electrolyte energy storage device using silicon oxide as a negative electrode, and having an improved capacity retention ratio in a charge-discharge cycle can be manufactured.

Another aspect of the present invention is a method for manufacturing a nonaqueous electrolyte energy storage device (β), the method including; producing a positive electrode; producing a negative electrode containing silicon oxide; and performing initial charge-discharge, wherein a ratio of an initial irreversible capacity of the positive electrode to an initial irreversible capacity of the negative electrode is 1.55 or less.

According to the manufacturing method (β), a nonaqueous electrolyte energy storage device using silicon oxide as a negative electrode, and having an improved discharge voltage retention ratio in the utilization region of the silicon oxide in a charge-discharge cycle can be manufactured.

Another aspect of the present invention is an energy storage apparatus configured by assembling a plurality of nonaqueous electrolyte energy storage devices, wherein at least one of the plurality of nonaqueous electrolyte energy storage devices is the nonaqueous electrolyte energy storage device (α) or the nonaqueous electrolyte energy storage device (β). The energy storage apparatus has a high capacity retention ratio in the charge-discharge cycle or a high discharge voltage retention ratio in the utilization region of the silicon oxide.

Hereinafter, the nonaqueous electrolyte energy storage device, the method for manufacturing the same, and the energy storage apparatus according to an embodiment of the present invention will be described in detail.

<Nonaqueous Electrolyte Energy Storage Device>

The nonaqueous electrolyte energy storage device according to an embodiment of the present invention has a positive electrode, a negative electrode, and a nonaqueous electrolyte. Hereinafter, a secondary battery will be described as an example of the nonaqueous electrolyte energy storage device. The positive electrode and the negative electrode usually form an electrode assembly alternately superposed by stacking or winding with a separator interposed therebetween. The electrode assembly is housed in a case, and the case is filled with the nonaqueous electrolyte. The nonaqueous electrolyte is interposed between the positive electrode and the negative electrode. As the case, a known metal case or resin case or the like, which is usually used as a case of a secondary battery, can be used.

(Positive Electrode)

The positive electrode has a positive electrode substrate and a positive active material layer disposed directly or via an intermediate layer on the positive electrode substrate.

The positive electrode substrate has conductivity. The term “having conductivity” means having a volume resistivity of 10⁷ Ω-cm or less which is measured in accordance with JIS-H-0505 (1975), and the term “non-conductivity” means that the volume resistivity is more than 10⁷ Ω-cm. As the material of the positive electrode substrate, a metal such as aluminum, titanium, tantalum, or stainless steel, or an alloy thereof is used. Among these, aluminum or an aluminum alloy is preferable from the viewpoint of electric potential resistance, high conductivity, and costs. Examples of the positive electrode substrate include a foil and a deposited film, and a foil is preferable from the viewpoint of costs. Therefore, the positive electrode substrate is preferably an aluminum foil or an aluminum alloy foil. Examples of the aluminum or aluminum alloy include A1085 and A3003 specified in JIS-H-4000 (2014).

The lower limit of the average thickness of the positive electrode substrate is preferably 5 μm, and more preferably 10 μm. The upper limit of the average thickness of the positive electrode substrate is preferably 50 μm, and more preferably 40 μm. By setting the average thickness of the positive electrode substrate to be equal to or greater than the above lower limit, the strength of the positive electrode substrate can be increased. By setting the average thickness of the positive electrode substrate to be equal to or less than the above upper limit, the energy density per volume of the secondary battery can be increased. For these reasons, it is preferable that the average thickness of the positive electrode substrate is equal to or greater than any of the above lower limits and equal to or less than any of the above upper limits. The term “average thickness” means an average value of thicknesses measured at any ten points. The same definition applies when the “average thickness” is used for other members and the like.

The intermediate layer is a layer arranged between the positive electrode substrate and the positive active material layer. The configuration of the intermediate layer is not particularly limited, and includes, for example, a resin binder and conductive particles. The intermediate layer contains, for example, conductive particles such as carbon particles to reduce contact resistance between the positive electrode substrate and the positive active material layer.

The positive active material layer contains a positive active material. The positive active material layer is usually formed of a so-called positive composite containing a positive active material. The positive composite forming the positive active material layer may contain optional components such as a conductive agent, a binder, a thickener, and a filler and the like as necessary.

The positive active material can be appropriately selected from known positive active materials usually used for lithium ion secondary batteries and the like. As the positive active material, a material capable of occluding and releasing lithium ions is usually used. Examples of the positive active material include lithium transition metal composite oxides having an α-NaFeO₂-type crystal structure, lithium transition metal composite oxides having a spinel-type crystal structure, polyanion compounds, chalcogenides, and sulfur. Examples of the lithium transition metal composite oxide having an α-NaFeO₂-type crystal structure include Li[LiₓNi₁₋ₓ]O₂ (0≤x<0.5), Li[LiₓNi_{γ}Co_{(1-x-γ)}]O₂ (0≤x<0.5, 0<γ<1), Li[LiₓNi_{γ}Mn_{β}Co_{(1-x-y-β)}]O₂ (0≤x<0.5, 0<γ, 0<β, 0.5<γ+β<1). Examples of the lithium transition metal composite oxide having a spinel-type crystal structure include LiₓMn₂O₄ and LiₓNi_{γ}Mn_{(2-γ)}O₄. Examples of the polyanion compound include LiFePO₄, LiMnPO₄, LiNiPO₄, LiCoPO₄, Li₃V₂(PO₄)₃, Li₂MnSiO₄, and Li₂CoPO₄F. Examples of the chalcogenide include titanium disulfide, molybdenum disulfide, and molybdenum dioxide. Atoms or polyanions in these materials may be partially substituted with atoms or anion species composed of other elements. In the positive active material layer, one of these positive active materials may be used singly, or two or more of these positive active materials may be mixed and used.

As the positive active material, a lithium transition metal composite oxide having an α-NaFeO₂-type crystal structure or a spinel-type crystal structure is preferable; a lithium transition metal composite oxide having an α-NaFeO₂-type crystal structure is more preferable; and Li[LiₓNi_{γ}Mn_{β}Co_{(1-x-γ-β)}]O₂ (0≤x<0.5, 0<γ, 0<β, 0.5<γ+β<1) is more preferable. In the above formula, the lower limit of x may be preferably 0, preferably more than 0, and more preferably 0.1. The upper limit of x may be preferably 0.4, and more preferably 0.3. The lower limit of the value of γ may be preferably 0.3, and more preferably 0.5. The upper limit of the value of γ may be preferably 0.9, and more preferably 0.8. The lower limit of the value of 8 may be preferably 0.1, more preferably 0.3, still more preferably 0.4, and yet still more preferably 0.5. The upper limit of the value of 1-x-γ-β may be preferably 1.0, more preferably 0.4, and still more preferably 0.1. 1-x-γ-β=0 may be used.

The average particle size of the positive active material is preferably 0.1 μm or more and 20 μm or less, for example. By setting the average particle size of the positive active material to be equal to or greater than the above upper limit, the positive active material is easily manufactured or handled. By setting the average particle size of the positive active material to be equal to or less than the above upper limit, the electron conductivity of the positive active material layer is improved. Here, the term “average particle size” means a value at which a volume-based integrated distribution calculated in accordance with KIS-Z-8819-2 (2001) is 50% based on a particle size distribution measured by a laser diffraction/scattering method for a diluted solution obtained by diluting particles with a solvent in accordance with JIS-Z-8825 (2013).

A crusher and a classifier and the like are used to obtain particles such as a positive active material in a predetermined shape. Examples of a crushing method include a method in which

a mortar, a ball mill, a sand mill, a vibratory ball mill, a planetary ball mill, a jet mill, a counter jet mill, a whirling airflow type jet mill, or a sieve or the like is used. At the time of crushing, wet type crushing in the presence of water or an organic solvent such as hexane can also be also used. As a classification method, a sieve or a wind force classifier or the like is used based on the necessity both in dry manner and in wet manner.

The lower limit of the content of the positive active material in the positive active material layer is preferably 70% by mass, more preferably 80% by mass, and still more preferably 90% by mass. The upper limit of the content of the positive active material is preferably 98% by mass, and more preferably 96% by mass. By setting the content of the positive active material within the above range, the electric capacity of the secondary battery can be further increased. The content of the positive active material in the positive active material layer can be equal to or greater than any of the above lower limits and equal to or less than any of the above upper limits.

The conductive agent is not particularly limited as long as it is a conductive material. Examples of such a conductive agent include graphite; carbon blacks such as furnace black and acetylene black; metals; and conductive ceramics. Examples of the shape of the conductive agent include a powdery shape and a fibrous shape. Among these, acetylene black is preferable from the viewpoint of electron conductivity and coatability.

The lower limit of the content of the conductive agent in the positive active material layer is preferably 1% by mass, and more preferably 2% by mass. The upper limit of the content of the conductive agent is preferably 10% by mass, and more preferably 5% by mass. By setting the content of the conductive agent within the above range, the electric capacity of the secondary battery can be increased. For these reasons, it is preferable that the content of the conductive agent is equal to or greater than any of the above lower limits and equal to or less than any of the above upper limits.

Examples of the binder include: thermoplastic resins such as fluororesin (polytetrafluoroethylene (PTFE), polyvinylidene fluoride (PVDF), etc.), polyethylene, polypropylene, and polyimide; elastomers such as ethylene-propylene-diene rubber (EPDM), sulfonated EPDM, styrene-butadiene rubber (SBR), and fluororubber; and polysaccharide polymers.

The lower limit of the content of the binder in the positive active material layer is preferably 0.5% by mass, and more preferably 2% by mass. The upper limit of the content of the binder is preferably 10% by mass, and more preferably 5% by mass. When the content of the binder is within the above-described range, the active material can be stably held. For these reasons, it is preferable that the content of the binder is equal to or greater than any of the above lower limits and equal to or less than any of the above upper limits.

Examples of the thickener include polysaccharide polymers such as carboxymethylcellulose (CMC) and methylcellulose. When the thickener has a functional group reactive with lithium and the like, the functional group may be deactivated by methylation or the like in advance.

The filler is not particularly limited. Examples of the filler include polyolefins such as polypropylene and polyethylene, silica, alumina, zeolite, glass, and alumina silicate.

The positive active material layer may contain a typical nonmetal element such as B, N, P, F, Cl, Br, or I, a typical metal element such as Li, Na, Mg, Al, K, Ca, Zn, Ga, or Ge, or a transition metal element such as Sc, Ti, V, Cr, Mn, Fe, Co, Ni, Cu, Mo, Zr, Nb, or W as a component other than the positive active material, the conductive agent, the binder, the thickener, and the filler.

(Negative Electrode)

The negative electrode has a negative electrode substrate and a negative active material layer disposed directly or via an intermediate layer on the negative electrode substrate. The configuration of the intermediate layer of the negative electrode is not particularly limited, and the intermediate layer can have the same configuration as that of the intermediate layer of the positive electrode.

The negative electrode substrate has conductivity. As the material of the negative electrode substrate, a metal such as copper, nickel, stainless steel, nickel-plated steel, or aluminum, or an alloy thereof is used. Among them, copper or a copper alloy is preferable. Example of the negative electrode substrate include a foil and a vapor deposition film, and a foil is preferable from the viewpoint of costs. Therefore, the negative electrode substrate is preferably a copper foil or a copper alloy foil. Examples of the copper foil include a rolled copper foil and an electrolytic copper foil.

The lower limit of the average thickness of the negative electrode substrate is preferably 3 μm, and more preferably 5 μm. The upper limit of the average thickness of the negative electrode substrate is preferably 30 μm, and more preferably 20 μm. By setting the average thickness of the negative electrode substrate to be equal to or greater than the above lower limit, the strength of the negative electrode substrate can be increased. By setting the average thickness of the negative electrode substrate to be equal to or less than the above upper limit, the energy density per volume of the secondary battery can be increased. For these reasons, it is preferable that the average thickness of the negative electrode substrate is equal to or greater than any of the above lower limits and equal to or less than any of the above upper limits.

The negative active material layer contains silicon oxide which is a negative active material. The negative active material layer is usually formed of a so-called negative composite containing a negative active material. The negative composite forming the negative active material layer may contain optional components such as a conductive agent, a binder, a thickener, and a filler as necessary. As the optional components such as a conductive agent, a binder, a thickener, and a filler, the same components as those in the positive active material layer can be used. The contents of these optional components in the negative active material layer can be within the ranges described as the contents of the components in the positive active material or the like.

The silicon oxide is usually present as particles. The silicon oxide is usually a compound represented by SiOx (0<x<2). The lower limit of x is preferably 0.8. The upper limit of x is preferably 1.2. In the silicon oxide particles, silicon (Si) and silicon dioxide (SiO₂) may coexist. The average particle size of the silicon oxide is preferably 0.1 μm or more and 20 μm or less, for example. By setting the average particle size of the silicon oxide to be equal to or greater than the above lower limit, the initial irreversible capacity (μAh/g) per unit mass of the silicon oxide tends to decrease, whereby the irreversible capacity of the positive electrode with respect to the initial irreversible capacity of the negative electrode is easily designed to a large value. By setting the average particle size of the silicon oxide to be equal to or less than the above upper limit, the electron conductivity of the negative active material layer is improved. Silicon oxide having a particle surface appropriately carbon-coated by a CVD method or the like for the purpose of imparting electron conductivity is preferably used as the negative active material.

The lower limit of the content of the silicon oxide in the negative active material may be preferably 1% by mass, more preferably 2% by mass, and still more preferably 4% by mass. By setting the content of the silicon oxide to be equal to or greater than the above lower limit, the discharge capacity of the secondary battery can be increased. Meanwhile, the upper limit of the content may be, for example, 100% by mass, and is preferably 30% by mass, more preferably 15% by mass, and still more preferably 8% by mass. By setting the content of the silicon oxide to be equal to or less than the above upper limit, the capacity retention ratio of the secondary battery in the charge-discharge cycle can be further increased. The content of the silicon oxide in the negative active material can be equal to or greater than any of the above lower limits and equal to or less than any of the above upper limits.

The negative active material layer preferably further contains graphite as the negative active material. Since the graphite is contained as the negative active material, the capacity retention ratio of the secondary battery in the charge-discharge cycle is further increased. Examples of the graphite include natural graphite and artificial graphite. Artificial graphite is preferable from the viewpoint that a material having stable physical properties can be obtained. The average particle size of the graphite can be, for example, 1 μm or more and 100 μm or less.

The lower limit of the graphite content in the negative active material may be, for example, 1% by mass, preferably 70% by mass, more preferably 85% by mass, and still more preferably 92% by mass. By setting the graphite content to be equal to or greater than the above lower limit, the capacity retention ratio of the secondary battery in the charge-discharge cycle can be further increased. Meanwhile, the upper limit of the content may be preferably 99% by mass, more preferably 98% by mass, and still more preferably 96% by mass. By setting the graphite content to be equal to or less than

the above upper limit, the discharge capacity of the secondary battery can be increased. The graphite content in the negative active material can be equal to or greater than any of the above lower limits and equal to or less than any of the above upper limits.

When the negative active material contains silicon oxide and graphite, the lower limit of the content of the silicon oxide in the total content of the silicon oxide and the graphite may be preferably 1% by mass, more preferably 2% by mass, and still more preferably 4% by mass. By setting the content of the silicon oxide to be equal to or greater than the above lower limit, the discharge capacity of the secondary battery can be increased. Meanwhile, the upper limit of the content may be, for example, 99% by mass, preferably 30% by mass, more preferably 15% by mass, and still more preferably 8% by mass. By setting the content of the silicon oxide to be equal to or less than the above upper limit, the capacity retention ratio of the secondary battery in the charge-discharge cycle can be further increased. The content of the silicon oxide in the total content of the silicon oxide and the graphite can be equal to or greater than any of the above lower limits and equal to or less than any of the above upper limits.

As the negative active material, a known negative active material other than the silicon oxide and the graphite, which is usually used for lithium ion secondary batteries and the like may be further contained. However, the lower limit of the total content of the silicon oxide and the graphite in the negative active material is preferably 90% by mass, and more preferably 99% by mass. Meanwhile, the upper limit of this total content may be 100% by mass. As described above, by using only the silicon oxide or only the silicon oxide and the graphite as the negative active material, the effects of the present invention can be more sufficiently exhibited.

The lower limit of the total content of the negative active material in the negative active material layer is preferably 70% by mass, more preferably 80% by mass, and still more preferably 90% by mass. The upper limit of the total content of the negative active material is preferably 98% by mass, and more preferably 97% by mass. By setting the total content of the negative active material within the above range, the electric capacity of the secondary battery can be further increased.

The negative active material layer may contain a typical nonmetal element such as B, N, P, F, Cl, Br, or I, a typical metal element such as Li, Na, Mg, Al, K, Ca, Zn, Ga, or Ge, or a transition metal element such as Sc, Ti, V, Cr, Mn, Fe, Co, Ni, Cu, Mo, Zr, Ta, Hf, Nb, or W as a component other than the negative active material, the conductive agent, the binder, the thickener, and the filler.

(Separator)

As the separator, for example, a woven fabric, a nonwoven fabric, or a porous resin film or the like is used. Among them, a porous resin film is preferable from the viewpoint of strength, and a nonwoven fabric is preferable from the viewpoint of liquid retention property of the nonaqueous electrolyte. As a main component of the separator, a polyolefin such as polyethylene or polypropylene is preferable from the viewpoint of strength, and polyimide or aramid or the like is preferable from the viewpoint of resistance to oxidation and decomposition. These resins may be composited.

An inorganic layer may be disposed between the separator and the electrode (usually, the positive electrode). The inorganic layer is a porous layer also called a heat resistant layer or the like. A separator having an inorganic layer formed on one surface or both surfaces of the porous resin film can also be used. The inorganic layer is usually composed of inorganic particles and a binder, and may contain other components. As the inorganic particles, Al₂O₃, SiO₂, and aluminosilicate and the like are preferable.

(Nonaqueous Electrolyte)

As the nonaqueous electrolyte, a known nonaqueous electrolyte normally used for a general nonaqueous electrolyte secondary battery (nonaqueous electrolyte energy storage device) can be used. The nonaqueous electrolyte contains, for example, a nonaqueous solvent and an electrolyte salt dissolved in the nonaqueous solvent.

As the nonaqueous solvent, it is possible to use a known nonaqueous solvent usually used as a nonaqueous solvent of a general nonaqueous electrolyte for an energy storage device. Examples of the nonaqueous solvent include cyclic carbonate, chain carbonate, ester, ether, amide, sulfone, lactone, and nitrile. Among these, it is preferable to use at least the cyclic carbonate or the chain carbonate, and it is more preferable to use the cyclic carbonate and the chain carbonate in combination. When the cyclic carbonate and the chain carbonate are used in combination, the volume ratio of the cyclic carbonate to the chain carbonate (cyclic carbonate:chain carbonate) is not particularly limited, but is preferably 5:95 or more and 50:50 or less, for example.

Examples of the cyclic carbonate include ethylene carbonate (EC), propylene carbonate (PC), butylene carbonate (BC), vinylene carbonate (VC), vinylethylene carbonate (VEC), chloroethylene carbonate, fluoroethylene carbonate (FEC), difluoroethylene carbonate (DFEC), styrene carbonate, catechol carbonate, 1-phenylvinylene carbonate, and 1,2-diphenylvinylene carbonate, and among these, EC is preferable.

Examples of the chain carbonate include diethyl carbonate (DEC), dimethyl carbonate (DMC), ethyl methyl carbonate (EMC), and diphenyl carbonate, and among these, EMC is preferable.

As the electrolyte salt, it is possible to use a known electrolyte salt usually used as an electrolyte salt of a general nonaqueous electrolyte for an energy storage device. Examples of the electrolyte salt include a lithium salt, a sodium salt, a potassium salt, a magnesium salt, and an onium salt, but a lithium salt is preferable.

Examples of the lithium salt include inorganic lithium salts such as LiPF₆, LiPO₂F₂, LiBF₄, LiClO₄, and LiN(SO₂F)₂, and lithium salts having a fluorinated hydrocarbon group, such as LiSO₃CF₃, LiN(SO₂CF₃)₂, LiN(SO₂C₂F₅)₂, LiN(SO₂CF₃)(SO₂C₄F₉), LiC(SO₂CF₃)₃ and LiC(SO₂C₂F₅)₃. Among these, an inorganic lithium salt is preferable, and LiPF₆ is more preferable.

The lower limit of the content of the electrolyte salt in the nonaqueous electrolyte is preferably 0.1 mol/dm³, more preferably 0.3 mol/dm³, still more preferably 0.5 mol/dm³, and particularly preferably 0.7 mol/dm³. Meanwhile, the upper limit is not particularly limited, but preferably 2.5 mol/dm³, more preferably 2 mol/dm³, and still more preferably 1.5 mol/dm³. The content of the electrolyte salt is preferably equal to or greater than any of the above lower limits and equal to or less than any of the above upper limits.

Other additives may be added to the nonaqueous electrolyte. As the nonaqueous electrolyte, a salt that is melted at normal temperature, ionic liquid, or a polymer solid electrolyte or the like can also be used.

(Initial Irreversible Capacity Ratio (Q′c/Q′a))

In the first embodiment of the present invention, the lower limit of the initial irreversible capacity ratio of the secondary battery (nonaqueous electrolyte energy storage device) (Q′c/Q′a: the initial irreversible capacity (Q′c) per unit area of the positive electrode with respect to the initial irreversible capacity (Q′a) per unit area of the negative electrode) may be 1.15, and preferably 1.20. Thus, by making the initial irreversible capacity of the negative electrode relatively small, the increase in the negative electrode potential in the state of DOD 100% or of being close thereto is suppressed as described above, whereby the capacity retention ratio of the nonaqueous electrolyte energy storage device in the charge-discharge cycle can be increased. The upper limit of the initial irreversible capacity ratio (Q′c/Q′a) may be, for example, 2.5, 2.0, or 1.6, and is preferably 1.55, more preferably 1.50, still more preferably 1.45., and yet still more preferably 1.40. By setting the initial irreversible capacity ratio (Q′c/Q′a) to be equal to or less than the above upper limit, the discharge voltage retention ratio in the utilization region of the silicon oxide in the charge-discharge cycle can be improved as described above. The initial irreversible capacity ratio (Q′c/Q′a) can be equal to or greater than any of the above lower limits and equal to or less than any of the above upper limits.

Examples of a method for setting the initial irreversible capacity ratio (Q′c/Q′a) to 1.15 or more include (1) the mass of the negative active material per unit area (that is, the capacity of the negative electrode) is reduced relative to the mass of the positive active material (that is, the capacity of the positive electrode), and (2) the negative active material is pre-doped with lithium or the like.

Specific methods of (1) above include relatively reducing the coating amount per unit area of the negative composite containing the negative active material, reducing the ratio of the negative active material in the negative composite, and using silicon oxide and graphite in combination as the negative active material so that the ratio of the silicon oxide is reduced. Because of a relative relationship with the mass of the positive active material (the capacity of the positive electrode), the type and mass per unit area of the positive active material may be adjusted.

Regarding (1) above, the upper limit of the ratio (N/P) of the initial charge capacity (N) per unit area of the negative electrode to the initial charge capacity (P) per unit area of the positive electrode is preferably 1.20, and more preferably 1.15. The initial irreversible capacity ratio (Q′c/Q′a) can be easily adjusted to 1.15 or more by setting the initial charge capacity ratio (N/P) to be equal to or less than the above upper limit, and preferably using a predetermined positive active material and negative active material in combination. The lower limit of the initial charge capacity ratio (N/P) may be, for example, 0.7, but is preferably 1.00, and more preferably 1.05. The initial charge capacity ratio (N/P) can be equal to or greater than any of the above lower limits and equal to or less than any of the above upper limits.

Specific methods of (2) above include a chemical technique using a reducing agent or the like and an electrochemical technique. Examples of the reducing agent used in the chemical technique include metallic lithium, and alkyllithium such as propyllithium or butyllithium. As the electrochemical technique, an electrode containing silicon oxide is produced, and a current is passed through the electrode containing silicon oxide in a charging direction with lithium as a counter electrode, whereby silicon oxide doped with any amount of lithium can be obtained. As described above, the electrode containing silicon oxide doped with lithium is removed, and combined with the positive electrode, whereby a secondary battery can be obtained.

On the contrary, when the initial irreversible capacity ratio (Q′c/Q′a) is desired to be reduced, for example, the mass of the negative active material per unit area in (1) above may be increased relative to the mass of the positive active material, and the amount of doping of lithium or the like into the negative active material in (2) above may be reduced.

In the second embodiment of the present invention, the upper limit of the initial irreversible capacity ratio (Q′c/Q′a) of the secondary battery (nonaqueous electrolyte energy storage device) is 1.55, preferably 1.50, and more preferably 1.45, and still more preferably 1.40. By setting the initial irreversible capacity ratio (Q′c/Q′a) to 1.55 or less, the accumulation of the high crystal phase is suppressed as described above, whereby the discharge voltage retention ratio in the utilization region of the silicon oxide in the charge-discharge cycle can be improved. By setting the initial irreversible capacity ratio (Q′c/Q′a) to 1.55 or less, a change in a discharge curve shape and a decrease in discharged energy due to repeated charge-discharge are suppressed, and the capacity retention ratio tends to be also increased. The lower limit of the initial irreversible capacity ratio (Q′c/Q′a) in the secondary battery according to the second embodiment is not particularly limited, but is preferably equal to or greater than the lower limit described as the first embodiment.

(Negative Electrode Potential in State of 100% DOD)

The upper limit of the negative electrode potential of the secondary battery (nonaqueous electrolyte energy storage device) in the state of 100% DOD may be, for example, 0.58 V vs. Li/Li⁺, but may be preferably 0.53 V vs. Li/Li⁺, more preferably 0.51 V vs. Li/Li⁺, and still more preferably 0.50 V vs. Li/Li⁺. As described above, by setting the negative electrode potential in the state of 100% DOD to be equal to or less than the above upper limit, the capacity retention ratio of the nonaqueous electrolyte energy storage device in the charge-discharge cycle can be further increased. Meanwhile, the lower limit of this negative electrode potential may be, for example, preferably 0.3 V vs. Li/Li⁺, more preferably 0.4 V vs. Li/Li⁺, more preferably 0.45 V vs. Li/Li⁺, and still more preferably 0.485 V vs. Li/Li⁺. By setting the negative electrode potential in the state of 100% DOD to be equal to or greater than the above lower limit, the discharge voltage retention ratio in the utilization region of the silicon oxide in the charge-discharge cycle can be improved, and the capacity of the secondary battery can be increased. The negative electrode potential in the state of 100% DOD can be equal to or higher than any of the above lower limits and equal to or lower than any of the above upper limits.

The constitution of the nonaqueous electrolyte energy storage device according to the present invention is not particularly limited, and examples thereof include cylindrical batteries, prismatic batteries (rectangular batteries), flat batteries, coin batteries, and button batteries.

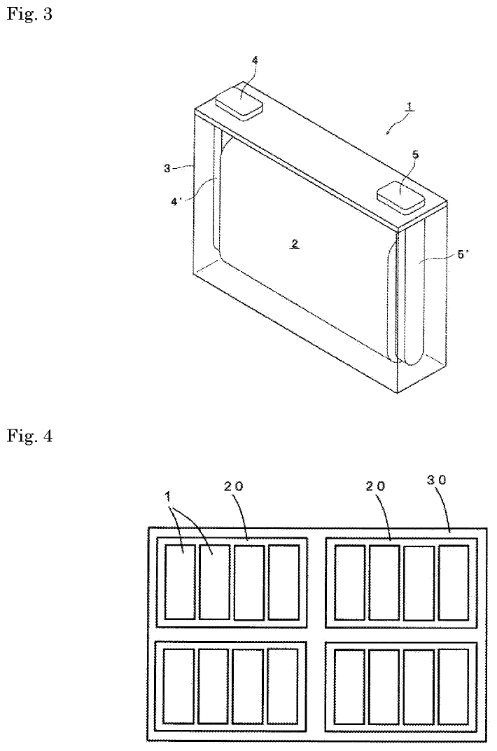

FIG. 3 is a schematic view of a rectangular nonaqueous electrolyte energy storage device 1 (nonaqueous electrolyte secondary battery) which is an embodiment of the nonaqueous electrolyte energy storage device according to the present invention. FIG. 3 is a view showing an inside of a case in a perspective manner. In the nonaqueous electrolyte energy storage device 1 shown in FIG. 3, an electrode assembly 2 is housed in a case 3. The electrode assembly 2 is formed by winding a positive electrode provided with a positive active material and a negative electrode provided with a negative active material via a separator. The positive electrode is electrically connected to a positive electrode terminal 4 through a positive electrode lead 4′, and the negative electrode is electrically connected to a negative electrode terminal 5 through a negative electrode lead 5′.

<Method for Manufacturing Nonaqueous Electrolyte Energy Storage Device>

The nonaqueous electrolyte energy storage device according to the first embodiment of the present invention can be manufactured by a method including; producing a positive electrode; producing a negative electrode containing silicon oxide; and performing initial charge-discharge, wherein a ratio of an initial irreversible capacity of the positive electrode to an initial irreversible capacity of the negative electrode is 1.15 or more.

The method for setting the initial irreversible capacity ratio of the positive electrode and the negative electrode (Q′c/Q′a; the initial irreversible capacity (Q′c) of the positive electrode to the initial irreversible capacity (Q′a) of the negative electrode) to 1.15 or more is as described above. Specific examples of a design procedure for the initial irreversible capacity ratio (Q′c/Q′a) include the following procedure. (1) The potential of the positive electrode in the state of 100% SOC and the potential of the positive electrode in the state of 100% DOD are set according to the type and composition of the positive active material. (2) The initial reversible capacity (mAh/g) and the initial irreversible capacity (mAh/g) per unit mass of the positive active material used are made known, and formulations such as the electrode density, void ratio, and thickness of the positive active material layer provided in the positive electrode actually used for the nonaqueous electrolyte energy storage device are then designed so that the initial irreversible capacity ratio (Q′c/Q′a) are as designed in relation to the negative electrode, to produce the positive electrode. For confirmation, using the produced positive electrode, the potential of the positive electrode set in (1) above is set as a charge upper limit potential and an end-of-discharge potential, and the charge capacity and discharge capacity are measured according to the above-mentioned measurement method of the charge capacity and the discharge capacity. From the difference between the measured charge capacity and discharge capacity, the initial irreversible capacity per unit area of the positive electrode can be obtained. (3) Similarly, the initial reversible capacity (mAh/g) and the initial irreversible capacity (mAh/g) per unit mass of the negative active material used are made known, and formulations such as the electrode density, void ratio, and thickness of the negative active material layer provided in the negative electrode actually used for the nonaqueous electrolyte energy storage device are then designed so that the initial irreversible capacity ratio (Q′c/Q′a) are as designed in relation to the positive electrode, to produce the negative electrode. For confirmation, using the produced negative electrode, a charge lower limit potential is set to 0.02 V (vs. Li/Li⁺), and an end-of-discharge potential is set to 2.0 V (vs. Li/Li⁺). The charge capacity and the discharge capacity are measured according to the above-mentioned measuring method of the charge capacity and the discharge capacity. From the difference between the measured charge capacity and discharge capacity, the initial irreversible capacity per unit area of the negative electrode can be obtained. (4) The production of the nonaqueous electrolyte energy storage device is confirmed to be allowed, in which the initial irreversible capacity ratio (Q′c/Q′a) is as designed based on the obtained initial irreversible capacity per unit area of the positive electrode and the initial irreversible capacity per unit area of the negative electrode.

The positive electrode and the negative electrode of the nonaqueous electrolyte energy storage device can be manufactured by a conventionally known method except that the ratio of the initial irreversible capacity of the positive electrode to the initial irreversible capacity of the negative electrode is set to 1.15 or more. The positive electrode can be produced, for example, by applying a positive composite paste to a positive electrode substrate directly or via an intermediate layer, followed by drying. The positive composite paste contains components constituting a positive active material layer (positive composite) such as a positive active material, and a dispersion medium. Similarly, the negative electrode can be produced, for example, by applying a negative composite paste to a negative electrode substrate directly or via an intermediate layer, followed by drying. The negative composite paste contains components constituting a negative active material layer (negative composite) such as a negative active material containing silicon oxide, and a dispersion medium.

The manufacturing method includes the steps of preparing a positive electrode and a negative electrode, forming an electrode assembly in which the positive electrode and the negative electrode are alternately superposed by stacking or winding the positive electrode and the negative electrode with a separator interposed between the electrodes, housing the positive electrode and the negative electrode (electrode assembly) in a case, injecting a nonaqueous electrolyte into the case through an injection port, and sealing the injection port. As described above, the nonaqueous electrolyte energy storage device before the initial charge-discharge can be assembled, followed by performing the initial charge-discharge. Through the initial charge-discharge, for example, a nonaqueous electrolyte energy storage device having a negative electrode potential of V₂ in the state of 100% DOD in FIG. 1 can be obtained. The “initial charge-discharge” refers to the first charge-discharge of a nonaqueous electrolyte energy storage device (uncharged/discharged nonaqueous electrolyte energy storage device) which has never been charged/discharged after assembly. The number of charge-discharge cycles in the initial charge-discharge may be 1 or 2, or may be 3 or more.

The nonaqueous electrolyte energy storage device according to the second embodiment of the present invention can be manufactured by a method including: producing a positive electrode; producing a negative electrode containing silicon oxide; and performing initial charge-discharge, wherein a ratio of an initial irreversible capacity of the positive electrode to an initial irreversible capacity of the negative electrode is 1.55 or less. A specific suitable form of the manufacturing method is the same as the method for manufacturing the nonaqueous electrolyte energy storage device according to the first embodiment described above except that the initial irreversible capacity ratio (Q′c/Q′a) of the positive electrode and the negative electrode is set to 1.55 or less and the lower limit thereof is not limited. A specific design procedure for setting the initial irreversible capacity ratio (Q′c/Q′a) of the positive electrode and the negative electrode to a predetermined value of 1.55 or less is also the same as the above-mentioned design procedure.

<Energy Storage Apparatus>

The nonaqueous electrolyte energy storage device of the present embodiment can be mounted as an energy storage apparatus configured by assembling a plurality of nonaqueous electrolyte energy storage devices 1 on a power source for automobiles such as electric vehicles (EV), hybrid vehicles (HEV), and plug-in hybrid vehicles (PHEV), a power source for electronic devices such as personal computers and communication terminals, or a power source for power storage, or the like. In this case, the technique of the present invention may be applied to at least one nonaqueous electrolyte energy storage device included in the energy storage apparatus.

FIG. 4 illustrates an example of an energy storage apparatus 30 formed by assembling energy storage units 20 in each of which two or more electrically connected nonaqueous electrolyte energy storage devices 1 are assembled. That is, the energy storage apparatus 30 includes a plurality of energy storage units 20. Each of the energy storage units 20 includes a plurality of nonaqueous electrolyte energy storage devices 1. The energy storage apparatus 30 may include a busbar (not illustrated) for electrically connecting two or more nonaqueous electrolyte energy storage devices 1 and a busbar (not illustrated) for electrically connecting two or more energy storage units 20. The energy storage unit 20 or the energy storage apparatus 30 may include a state monitor (not illustrated) for monitoring the state of one or more nonaqueous electrolyte energy storage devices.

### Other Embodiments

The present invention is not limited to the aforementioned embodiments, and, in addition to the aforementioned embodiments, can be carried out in various modes with alterations and/or improvements being made. For example, it is not necessary to provide an intermediate layer in the positive electrode or the negative electrode. The positive electrode and the negative electrode of the nonaqueous electrolyte energy storage device are not required to have a distinct layer structure. For example, the positive electrode may have a structure in which a positive active material is carried on a mesh-shaped positive electrode substrate.

In the above-described embodiment, an embodiment in which the nonaqueous electrolyte energy storage device is a nonaqueous electrolyte secondary battery has been mainly described, but the nonaqueous electrolyte energy storage device may be other nonaqueous electrolyte energy storage device. Examples of the other nonaqueous electrolyte energy storage device include capacitors (electric double layer capacitors and lithium ion capacitors).

### EXAMPLES

Hereinafter, the present invention will be described more specifically by way of examples, but the present invention is not limited to the following examples.

### Example 1

(Measurement of Irreversible Capacity Per Unit Mass of Positive Active Material)

As a positive active material, LiNi_{1/2}Mn_{3/10}Co_{1/5}O₂, which was a lithium transition metal composite oxide having an α-NaFeO₂-type crystal structure, was prepared. This positive active material is known to have an initial charge capacity of 191.0 mAh/g, an initial discharge capacity of 166.9 mAh/g, and an initial irreversible capacity of 24.1 mAh/g when a charge upper limit potential is 4.33 V vs. Li/Li⁺ and an end-of-discharge potential is 2.85 V vs. Li/Li⁺.

(Measurement of Irreversible Capacity Per Unit Mass of Negative Active Material)

As a negative active material, a mixture of silicon oxide (SiO) and graphite (Gr) was prepared. The content of the silicon oxide with respect to the total amount of the silicon oxide and the graphite was 2.5% by mass. This negative active material is known to have an initial charge capacity of 410.0 mAh/g, an initial discharge capacity of 374.3 mAh/g, and an initial irreversible capacity of 35.7 mAh/g when a lower limit charge potential is 0.02 V vs. Li/Li⁺ and an end-of-discharge potential is 2.0 V vs. Li/Li⁺.

(Production of Positive Electrode and Negative Electrode)

A positive composite paste was produced, which contained a positive active material, acetylene black (AB), and polyvinylidene fluoride (PVDF) at a mass ratio of 93:3.5:3.5 (in terms of solid matter) with N-methylpyrrolidone (NMP) as a dispersion medium. This positive composite paste was applied to a strip-shaped aluminum foil as a positive electrode substrate, and dried to remove NMP. The amount of the positive composite paste applied per 1 cm² was 19.1 mg/cm² in terms of solid content. This was pressed by a roller press to form a positive active material layer, and then dried under reduced pressure to obtain a positive electrode. The initial charge capacity (P) per 1 cm² of the obtained positive electrode was 3392.7 μAh/cm², and the initial irreversible capacity (Q′c) per 1 cm² was 428.1 μAh/cm².

A negative composite paste was produced, which contained a negative active material (SiO+Gr), styrene butadiene rubber (SBR), and carboxymethyl cellulose (CMC) at a mass ratio of 97:2:1 (in terms of solid content) with water as a dispersion medium. This negative composite paste was applied to both surfaces of a strip-shaped copper foil current collector as a negative electrode substrate, and dried to remove water. The amount of the negative composite paste applied per 1 cm² was 9.8 mg/cm² in terms of solid content. This was pressed by a roller press to form a negative active material layer, and then dried under reduced pressure to obtain a negative electrode. The initial charge capacity (N) per 1 cm² of the obtained negative electrode was 3897.5 μAh/cm², and the initial irreversible capacity (Q′a) per 1 cm² was 339.4 μAh/cm².

The ratio (Q′c/Q′a) of the initial irreversible capacity of the positive electrode to the initial irreversible capacity of the negative electrode thus obtained was 1.26. The ratio (N/P) of the initial charge capacity (N) per 1 cm² of the negative electrode to the initial charge capacity (P) per 1 cm² of the positive electrode was 1.15.

(Preparation of Nonaqueous Electrolyte)

A nonaqueous electrolyte was prepared by mixing lithium hexafluorophosphate (LiPF₆) as an electrolyte salt so as to have a content of 1.0 mol/dm³ in a nonaqueous solvent obtained by mixing EC, EMC, and DMC at a volume ratio of 30:35:35.

(Production of Nonaqueous Electrolyte Energy Storage Device)

As a separator, a microporous polyolefin membrane having an inorganic layer formed on one surface was prepared. An electrode assembly was produced by laminating the positive electrode and the negative electrode with the separator interposed between the electrodes. The electrode assembly was housed in a metal resin composite film case. The nonaqueous electrolyte was injected into the case, and the case was sealed by thermal welding.

(Initial Charge-Discharge)

The obtained nonaqueous electrolyte energy storage device before charge-discharge was subjected to

initial charge-discharge for 3 cycles at 25° C. in the following manner. In the 1st cycle, constant current constant voltage charge was performed at a charge current of 0.2 C to a charge end voltage of 4.25 V for a total charge time of 7 hours, followed by a rest period of 10 minutes. Subsequently, constant current discharge was performed at a discharge current of 0.2 C to an end-of-discharge voltage of 2.75 V, followed by a rest period of 10 minutes. In the second and third cycles, constant current constant voltage charge was performed at a charge current of 1 C to a charge end voltage of 4.25 V for a total charge time of 3 hours, followed by a rest period of 10 minutes. Subsequently, constant current discharge was performed at a discharge current of 1 C to an end-of-discharge voltage of 2.75 V, followed by a rest period of 10 minutes. The initial charge-discharge was performed by the above operation. As a result, a nonaqueous electrolyte energy storage device of Example 1 was obtained.

Furthermore, constant current discharge was performed at a discharge current of 0.2 C to an end-of-discharge voltage of 2.75 V, to provide an open circuit state for 10 minutes or more, and a negative electrode potential was measured. The negative electrode potential obtained in the state of 100% DOD after the initial charge-discharge was 0.48 V vs. Li/Li⁺.

### Example 2 and Comparative Examples 1 and 2

Nonaqueous electrolyte energy storage devices of Example 2 and Comparative Examples 1 and 2 were obtained in the same as in Example 1 except that the content of silicon oxide with respect to the total amount of the silicon oxide and graphite as a negative active material, and the mass of a negative composite applied were as shown in Table 1. The initial charge capacities (P, N) and the initial irreversible capacities (Q′c, Q′a) per 1 cm² of the positive electrode and the negative electrode in each of the obtained nonaqueous electrolyte energy storage devices, the initial irreversible capacity ratios (Q′c/Q′a), the initial charge capacity ratios (NIP), and the negative electrode potentials in the state of 100% DOD after initial charge-discharge, and the like are shown in Table 1.

### [Evaluation] (Capacity Retention Ratio in Charge-Discharge Cycle)

Each of the obtained nonaqueous electrolyte energy storage devices of Examples 1 and 2 and Comparative Examples 1 and 2 was subjected to a charge-discharge cycle test in the following manner. In a constant temperature bath at 45° C., constant current constant voltage charge was performed at a charge current of 1.0 C to a charge end voltage of 4.25 V for a total charge time of 3 hours, followed by a rest period of 10 minutes. Subsequently, constant current discharge was performed at a discharge current of 1.0 C to an end-of-discharge voltage of 2.75 V, followed by a rest period of 10 minutes. This charge-discharge was carried out for 50 cycles. The ratio of the discharge capacity of the 50th cycle to the discharge capacity of the 1st cycle in this charge-discharge cycle test was obtained as the capacity retention ratio in the charge-discharge cycle. Tables 1 and 5 show the capacity retention ratios of the obtained nonaqueous electrolyte energy storage devices of Examples 1 and 2 and Comparative Examples 1 and 2 in the charge-discharge cycle.

TABLE 1

| | | | | Comparative | Comparative |
|---|---|---|---|---|---|
| | | Example 1 | Example 2 | Example 1 | Example 2 |
| Positive | Initial charge capacity per 1 g of | 191.0 | 191.0 | 191_0 | 191.0 |
| electrode | active material [mAh/g] | | | | |
| | Initial discharge capacity per 1 g of | 166.9 | 166.9 | 166.9 | 166,9 |
| | active material [mAh/g] | | | | |
| | Initial irreversible capacity per 1 g of | 24,1 | 24.1 | 24.1 | 24.1 |
| | active material [mAh/g] | | | | |
| | Mass of composite applied | 19.1 | I 9.1 | 19.1 | 19.1 |
| | [mg/cm²] | | | | |
| | Amount of active material in | 93 | 93 | 93 | 93 |
| | composite [% by mass] | | | | |
| | Initial charge capacity per 1 cm² of | 3392.7 | 3392.7 | 3392.7 | 3392.7 |
| | positive electrode (P) [μAh/cm²] | | | | |
| | Initial irreversible capacity per 1 cm² | 428.1 | 428.1 | 428.1 | 428.1 |
| | of positive electrode (Q′c) [μAh/cm²] | | | | |
| Negative | SiO/(SiO + Gr) | 2.5 | 5 | 5 | 5 |
| electrode | [% by mass] | | | | |
| | Initial charge capacity per 1 g of active | 410.0 | 448.0 | 448.0 | 448.0 |
| | material [mAh/g] | | | | |
| | Initial discharge capacity per 1 g of | 374.3 | 401.7 | 401.7 | 401.7 |
| | active material [mAh/g] | | | | |
| | Initial irreversible capacity per 1 g of | 35.7 | 46.3 | 46.3 | 46.3 |
| | active material [mAh/g] | | | | |
| | Mass of composite applied | 9.8 | 8_3 | 9.8 | 8.4 |
| | [mg/cm²] | | | | |
| | Amount of active material in | 97 | 97 | 97 | 97 |
| | composite [% by mass] | | | | |
| | Initial charge capacity per 1 cm² of | 3897.5 | 3606.8 | 4258.7 | 3650.3 |
| | negative electrode (N) [μAh/cm²] | | | | |
| | Initial irreversible capacity per 1 cm² | 339.4 | 372.8 | 440.1 | 377.3 |
| | of negative electrode (Q′a) [μAh/cm²] | | | | |

| | | | | |
|---|---|---|---|---|
| Initial irreversible capacity ratio Q′c/Q′a | 1.26 | 1.15 | 0.97 | 1.13 |
| Initial charge capacity ratio N/P | 1.15 | 1.06 | 1.26 | 1.08 |
| Negative electrode potential in state of | 0.48 | 0.51 | 0.56 | 0.54 |
| 100% DOD [V vs.Li/Li⁺] | | | | |
| Capacity retention ratio [%] | 90 | 85 | 82 | 84 |

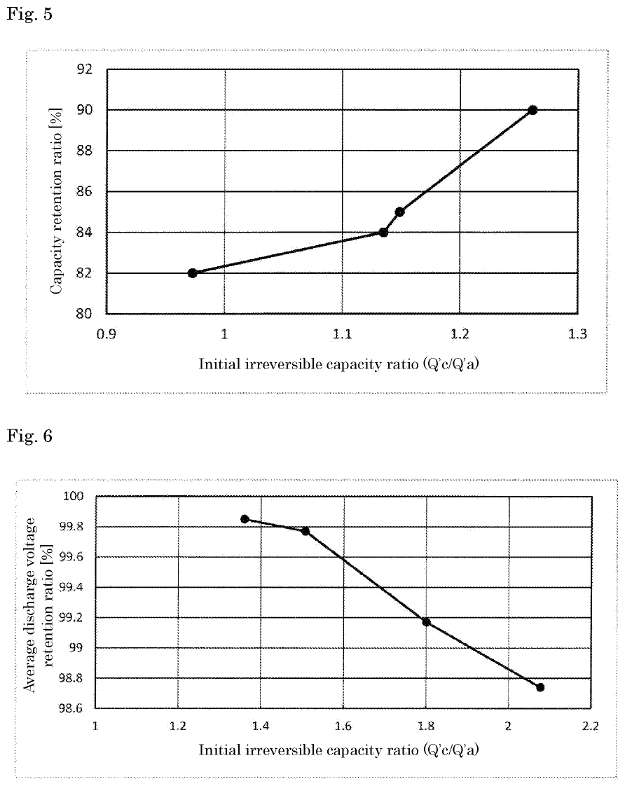

As shown in FIG. 5, it can be seen that a critical point is between 1.13 and 1.15 in the initial irreversible capacity ratio (Q′c/Q′a), and when the initial irreversible capacity ratio (Q′c/Q′a) is 1.15 or more, the capacity retention ratio in the charge-discharge cycle is remarkably improved.

In Patent Document 1, the following (1), (2), and (3) in a nonaqueous electrolyte secondary battery using silicon oxide as a negative electrode are described: (1) a positive electrode containing a Li-containing transition metal oxide having a predetermined composition and a negative electrode containing SiOx and graphite are used to adjust the initial charge-discharge efficiency of the positive electrode to be lower than the initial charge-discharge efficiency of the negative electrode; (2) thus, by adjusting the initial charge-discharge efficiencies of the positive electrode and the negative electrode, the potential of the negative electrode when the battery is discharged to 2.5 V is reduced to 1.0 V or less based on Li; and (3) thus, the potential of the negative electrode is set to 1.0 V or less based on Li to allow good charge-discharge cycle characteristics to be secured (Patent Document 1[0014]). However, while the initial charge-discharge efficiency (initial discharge capacity/initial charge capacity) of the positive electrode in Comparative Examples 1 and 2 is about 0.87 (≈166.9/191.0), the initial charge-discharge efficiency of the negative electrode is about 0.90 (≈401.7/448.0), and the initial charge-discharge efficiency of the positive electrode is lower. In both Comparative Examples 1 and 2 above, the negative electrode potential in the state of 100% DOD is lower than 1.0 V vs. Li/Li⁺. That is, although Comparative Examples 1 and 2 are the inventions of Patent Document 1, the capacity retention ratio in the charge-discharge cycle cannot be said to be sufficient. That is, it can be said that there is a limit to the improvement of the capacity retention ratio in the charge-discharge cycle even if only the magnitude relationship between the initial charge-discharge efficiencies of the positive electrode and the negative electrode is focused as in the invention of Patent Document 1. Meanwhile, it can be seen that the capacity retention ratio in the charge-discharge cycle can be remarkably improved by paying attention to the ratio of the absolute amounts of the irreversible capacities of the positive electrode and the negative electrode and setting the ratio to a predetermined value (1.15) or more.

### Example 31

(Measurement of Irreversible Capacity Per Unit Mass of Positive Active Material)

As a positive active material, LiNi_{0.8}Mn_{0.1}Co_{0.1}O₂, which was a lithium transition metal composite oxide having an α-NaFeO₂-type crystal structure, was prepared. This positive active material is known to have an initial charge capacity of 230.7 mAh/g, an initial discharge capacity of 199.2 mAh/g, and an initial irreversible capacity of 31.5 mAh/g when a charge upper limit potential is 4.33 V vs. Li/Li⁺ and an end-of-discharge potential is 2.85 V vs. Li/Li⁺.

(Measurement of Irreversible Capacity Per Unit Mass of Negative Active Material)

As a negative active material, a mixture of silicon oxide (SiO) and graphite (Gr) was prepared. The mass ratio of the silicon oxide to the graphite was set to 10:90. This negative active material is known to have an initial charge capacity of 476.7 mAh/g, an initial discharge capacity of 435.9 mAh/g, and an initial irreversible capacity of 40.8 mAh/g when a lower limit charge potential is 0.02 V vs. Li/Li⁺ and an end-of-discharge potential is 2.0 V vs. Li/Li⁺.

(Production of Positive Electrode and Negative Electrode)

A positive composite paste was produced, which contained a positive active material, acetylene black (AB), and polyvinylidene fluoride (PVDF) at a mass ratio of 93:3.5:3.5 (in terms of solid matter) with N-methylpyrrolidone (NMP) as a dispersion medium. This positive composite paste was applied to a strip-shaped aluminum foil as a positive electrode substrate, and dried to remove NMP. The amount of the positive composite paste applied per 1 cm² was set to 1.655 mg/cm² in terms of solid content. This was pressed by a roller press to form a positive active material layer, and then dried under reduced pressure to obtain a positive electrode. The initial charge capacity (P) per 1 cm² of the obtained positive electrode was 335.0 μAh/cm², and the initial irreversible capacity (Q′c) per 1 cm² was 48.5 μAh/cm².

A negative composite paste was produced, which contained a negative active material (SiO+Gr), styrene butadiene rubber (SBR), and carboxymethyl cellulose (CMC) at a mass ratio of 97:2:1 (in terms of solid content) with water as a dispersion medium. This negative composite paste was applied to both surfaces of a strip-shaped copper foil current collector as a negative electrode substrate, and dried to remove water. The amount of the negative composite paste applied per 1 cm² was 0.90 mg/cm² in terms of solid content. This was pressed by a roller press to form a negative active material layer, and then dried under reduced pressure to obtain a negative electrode. The initial charge capacity (N) per 1 cm² of the obtained negative electrode was 416.4 μAh/cm², and the initial irreversible capacity (Q′a) per 1 cm² was 35.6 μAh/cm².

The ratio (Q′c/Q′a) of the initial irreversible capacity of the positive electrode to the initial irreversible capacity of the negative electrode thus obtained was 1.36. The ratio (N/P) of the initial charge capacity (N) per 1 cm² of the negative electrode to the initial charge capacity (P) per 1 cm² of the positive electrode was 1.17.

A nonaqueous electrolyte energy storage device of Example 3 was obtained by production and initial charge-discharge in the same manner as in Example 1 except that a nonaqueous electrolyte was prepared in the same manner as in Example 1, and the positive electrode and the negative electrode were used.

Furthermore, constant current discharge was performed at a discharge current of 0.2 C to an end-of-discharge voltage of 2.75 V, to provide an open circuit state for 10 minutes or more, and a negative electrode potential was measured. The negative electrode potential obtained in the state of 100% DOD after the initial charge-discharge was 0.524 V vs. Li/Li⁺.

### Examples 4 to 6

Nonaqueous electrolyte energy storage devices of Examples 4 to 6 were obtained in the same manner as in Example 3 except that the mass of a positive composite applied and the mass of a negative composite were as shown in Table 2. The initial charge capacities (P, N) and the initial irreversible capacities (Q′c, Q′a) per 1 cm² of the positive electrode and the negative electrode in each of the obtained nonaqueous electrolyte energy storage devices, the initial irreversible capacity ratios (Q′c/Q′a), the initial charge capacity ratios (N/P), and the negative electrode potentials in the state of 100% DOD after initial charge-discharge, and the like are shown in Table 2.

### [Evaluation] (Discharge Voltage Retention Ratio and Energy Retention Ratio in Utilization Region of Silicon Oxide in Charge-Discharge Cycle)

Each of the obtained nonaqueous electrolyte energy storage devices of Examples 3 to 6 was subjected to a charge-discharge cycle test in the following manner. In a constant temperature bath at 25° C., constant current constant voltage charge was performed at a charge current of 1.0 C to a charge end voltage of 4.25 V for a total charge time of 3 hours, followed by a rest period of 10 minutes. Subsequently, constant current discharge was performed at a discharge current of 1.0 C to an end-of-discharge voltage of 2.75 V, followed by a rest period of 10 minutes. This charge-discharge was carried out for 50 cycles.

In the negative electrode of each of the nonaqueous electrolyte energy storage devices of Examples 3 to 6, the range of 50% DOD to 100% DOD was defined as the region where silicon oxide was mainly utilized. The ratio of the average discharge voltage in the above range of the 50th cycle to the average discharge voltage in the range of 50% DOD to 100% DOD in the 1st cycle in the above charge-discharge cycle test was determined as the average discharge voltage retention ratio. The ratio of energy discharged in the above range of the 50th cycle to energy discharged in the range of 50% DOD to 100% DOD in the 1st cycle in this charge-discharge cycle test was determined as the energy retention ratio. Tables 2 and FIGS. 6 and 7 show the average discharge voltage retention ratios and the energy retention ratios of the obtained nonaqueous electrolyte energy storage devices of Examples 3 and 6 in the charge-discharge cycle.

TABLE 2

| | | Example 3 | Example 4 | Example 5 | Example 6 |
|---|---|---|---|---|---|
| Positive | Initial charge capacity per 1 g of | 230.7 | 230_7 | 230.7 | 230.7 |
| electrode | active material [mAh/g] | | | | |
| | Initial discharge capacity per 1 g of | 199.2 | 199.2 | 199.2 | 199.2 |
| | active material [mAh/g] | | | | |
| | Initial irreversible capacity per 1 g of | 31.5 | 31.5 | 31.5 | 31.5 |
| | active material [mAh/g] | | | | |
| | Mass of composite applied [mg/cm²] | 1.655 | 1.695 | 1.684 | 1.703 |
| | Amount of active material in | 93 | 93 | 93 | 93 |
| | composite [% by mass] | | | | |
| | Initial charge capacity per 1 cm² of | 355.0 | 363.6 | 361.3 | 365.3 |
| | positive electrode (P) [μAh/cm²] | | | | |
| | Initial irreversible capacity per 1 cm² | 48.5 | 49.6 | 49.3 | 49.9 |
| | of positive electrode (Q′c) [μAh/cm²] | | | | |
| Negative | SiO/(SiO + Gr) | 10 | 10 | 10 | 10 |
| electrode | [% by mass] | | | | |
| | Initial charge capacity per 1 g of active | 476.7 | 476.7 | 476.7 | 476.7 |
| | material [mAh/g] | | | | |
| | Initial discharge capacity per 1 g of | 435.9 | 435.9 | 435.9 | 435.9 |
| | active material [mAh/g] | | | | |
| | Initial irreversible capacity per 1 g of | 40.8 | 40.8 | 40.8 | 40.8 |
| | active material [mAh/g] | | | | |
| | Mass of composite applied | 0.90 | 0.83 | 0.69 | 0.61 |
| | [mg/cm²] | | | | |
| | Amount of active material in | 97 | 97 | 97 | 97 |
| | composite [% by mass] | | | | |
| | Initial charge capacity per 1 cm² of | 416.4 | 384.8 | 320.1 | 280.5 |
| | negative electrode (N) [μAh/cm²] | | | | |
| | Initial irreversible capacity per 1 cm² | 35.6 | 32.9 | 27.4 | 24.0 |
| | of negative electrode (Q′a) [μAh/cm²] | | | | |

| | | | | |
|---|---|---|---|---|
| Initial irreversible capacity ratio Q′c/Q′a | 1.36 | 1.51 | 1.80 | 2,08 |
| Initial charge capacity ratio N/P | 1.17 | 1.06 | 0.89 | 0.77 |
| Negative electrode potential in state of | 0.524 | 0.487 | 0.447 | 0.408 |
| 100% DOD [V vs.Li/Li⁺] | | | | |
| Average discharge voltage retention ratio | 99.85 | 99.77 | 99 17 | 98.74 |
| in range of 50% DOD to 100% DOD [%] | | | | |
| Energy retention ratio | 95.9 | 95.0 | 92.2 | 90.1 |
| in range of 50% DOD to 100% DOD [%] | | | | |

As shown in Table 2 and FIGS. 6 and 7, it can be seen that when the initial irreversible capacity ratio (Q′c/Q′a) is 1.55 or less, the discharge voltage retention ratio and the energy retention ratio in the utilization region of the silicon oxide in the charge-discharge cycle (the range of 50% DOD to 100% DOD in each of the nonaqueous electrolyte energy storage devices of Examples 3 to 6) are significantly improved.

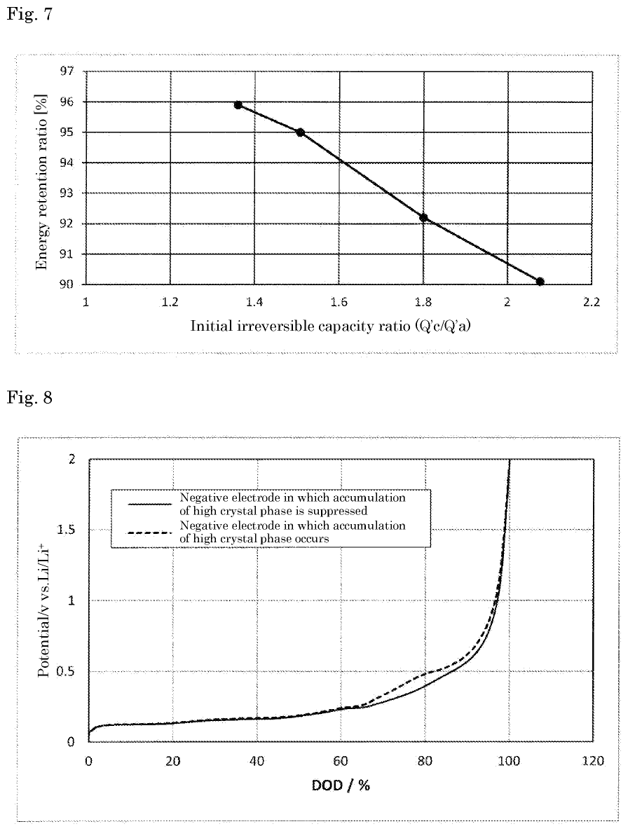

FIG. 8 shows, as examples, the discharge curve of the negative electrode in which the accumulation of the high crystalline phase occurs, and the discharge curve of the negative electrode in which the accumulation of the high crystalline phase is suppressed in the nonaqueous electrolyte energy storage device including the negative electrode containing silicon oxide. It can be seen that, when the accumulation of the high crystal phase occurs, the discharge potential of the negative electrode increases in the range of 60% DOD to 100% DOD, whereby the average discharge voltage of the nonaqueous electrolyte energy storage device including the negative electrode decreases.

### INDUSTRIAL APPLICABILITY

The present invention can be applied to a nonaqueous electrolyte energy storage device and the like used as a power source for electronic devices such as personal computers and communication terminals, and automobiles and the like.

### DESCRIPTION OF REFERENCE SIGNS

1: Nonaqueous electrolyte energy storage device
2: Electrode assembly
3: Case
4: Positive electrode terminal
4′: Positive electrode lead
5: Negative electrode terminal
5′: Negative electrode lead
20: Energy storage unit
30: Energy storage apparatus

1. A nonaqueous electrolyte energy storage device comprising:
a positive electrode; and
a negative electrode containing silicon oxide,
wherein a ratio of an initial irreversible capacity of the positive electrode to an initial irreversible capacity of the negative electrode is 1.15 or more.

2. The nonaqueous electrolyte energy storage device according to claim 1, wherein an open circuit potential of the negative electrode in a state of a depth of discharge of 100% is 0.53 V vs. Li/Li⁺ or less.

3. The nonaqueous electrolyte energy storage device according to claim 1, wherein the ratio of the initial irreversible capacity of the positive electrode to the initial irreversible capacity of the negative electrode is 1.55 or less.

4. The nonaqueous electrolyte energy storage device according to claim 1, wherein an open circuit potential of the negative electrode in the state of a depth of discharge of 100% is 0.485 V vs. Li/Li⁺ or more.

5. A nonaqueous electrolyte energy storage device comprising:
a positive electrode; and
a negative electrode containing silicon oxide,
wherein a ratio of an initial irreversible capacity of the positive electrode to an initial irreversible capacity of the negative electrode is 1.55 or less.

6. The nonaqueous electrolyte energy storage device according to claim 5, wherein an open circuit potential of the negative electrode in the state of a depth of discharge of 100% is 0.485 V vs. Li/Li⁺ or more.

7. The nonaqueous electrolyte energy storage device according to claim 1, wherein the negative electrode further contains graphite.

8. The nonaqueous electrolyte energy storage device according to claim 1, wherein the positive electrode contains a lithium transition metal composite oxide having an α-NaFeO₂-type crystal structure or a spinel-type crystal structure.

9. A method for manufacturing a nonaqueous electrolyte energy storage device,
the method comprising:
producing a positive electrode;
producing a negative electrode containing silicon oxide; and
performing initial charge-discharge,
wherein a ratio of an initial irreversible capacity of the positive electrode to an initial irreversible capacity of the negative electrode is 1.15 or more.

10. A method for manufacturing a nonaqueous electrolyte energy storage device,
the method comprising:
producing a positive electrode;
producing a negative electrode containing silicon oxide; and
performing initial charge-discharge,
wherein a ratio of an initial irreversible capacity of the positive electrode to an initial irreversible capacity of the negative electrode is 1.55 or less.

11. An energy storage apparatus configured by assembling a plurality of nonaqueous electrolyte energy storage devices,
wherein at least one of the plurality of nonaqueous electrolyte energy storage devices is the nonaqueous electrolyte energy storage device according to claim 1.

12. The nonaqueous electrolyte energy storage device according to claim 5, wherein the negative electrode further contains graphite.

13. The nonaqueous electrolyte energy storage device according to claim 5, wherein the positive electrode contains a lithium transition metal composite oxide having an α-NaFeO₂-type crystal structure or a spinel-type crystal structure.

14. An energy storage apparatus configured by assembling a plurality of nonaqueous electrolyte energy storage devices,
wherein at least one of the plurality of nonaqueous electrolyte energy storage devices is the nonaqueous electrolyte energy storage device according to claim 5.
